(19) United States
(12) Patent Application Publication
(10) Pub. No.: US 2014/0100714 A1
(43) Pub. Date: Apr. 10, 2014

(54) VEHICULAR SQUEAK AND RATTLE DETECTION

(71) Applicant: FORD GLOBAL TECHNOLOGIES, LLC, Dearborn, MI (US)

(72) Inventors: Mitchell L. Linn, New Hudson, MI (US); Francois Charette, Canton, MI (US); Bhaskara R. Tadikamalla, Canton, MI (US); James A. Birley, Bingham Farms, MI (US)

(73) Assignee: FORD GLOBAL TECHNOLOGIES, LLC, DEARBORN, MI (US)

(21) Appl. No.: 13/644,421

(22) Filed: Oct. 4, 2012

(51) Int. Cl. G01M 17/00

(52) U.S. Cl. 701/2; 701/29.4

(57) ABSTRACT

A method for detecting buzz, squeak, or rattle of interior components in a vehicle. A sine sweep signal is output through speakers of an audio system mounted in the vehicle capable of causing buzz, squeak, and rattle by defective installed parts in the vehicle. Audible sounds within the vehicle are recorded by a portable test unit during the outputting of the sine sweep signal. A component of the recorded audible sounds corresponding to the direct recording of the sweep signal is removed. Recorded audible sounds are recorded without the component to determine if a predetermined threshold is exceeded. A vehicle repair indication is generated in response to a determination that the sound exceeds the predetermined threshold.

### CROSS REFERENCE TO RELATED APPLICATIONS

Not Applicable.

### STATEMENT REGARDING FEDERALLY SPONSORED RESEARCH

Not Applicable.

### BACKGROUND OF INVENTION

The present invention relates in general to vehicle noise and vibration detection systems, and more specifically, to an end of line test for cabin buzz, squeak, and rattle.

Original equipment manufacturers (OEM) utilize as many end of line inspections as possible to ensure product quality. If products delivered to the consumer exhibit defects, then such customers will be dissatisfied which may result in increased warranty cost by the OEM for repairing the defective product or loss of future sales to the customer. As a result, end of line quality checks are critical for an OEM, as the end of line quality check is a last test for identifying any problems with the product prior to it being sold to a customer.

Historically, most of the end of line quality inspections are performed subjectively by operators. These subjective inspections are typically not reliable because they are highly dependent on the operator and do not allow for precisely tracking a single number metric using statistical process control. An operator of the test essentially gives a “go/no-go” metric. Furthermore, since the inspection can take more time in comparison to the cycle time of the assembly line, the OEM has to resort to performing audit sampling of the products. This results in only a certain percentage of the products being end of the line tested. As a result, the percentage of products being sold to the customer that may have a quality issue may be too high.

### SUMMARY OF INVENTION

In one aspect of the invention, an objective noise detection test uses an output from an audio system to excite parts in the interior of the vehicle for determining whether noise defects are present within the vehicle. A base station unit generates a sine sweep signal that is received over a dedicated frequency on the radio and is output over the vehicle speaker system. A sound recording of the sound output is captured by a portable testing device mounted within the vehicle. The sound recording is transmitted to a base station unit where the original sine sweep signal and other background noise is removed from the original sound data file. The resulting sound data file is compared to a predetermined threshold for determining whether any defects exist in the vehicles that generate undesirable noise. A pass/fail determination is made and a signal is transmitted back to the portable test unit disposed within the vehicle for alerting the operator whether the vehicle passed or failed the buzz, squeak, and rattle test. Thus, an objective test is completed within a 60 second cycle which allows each vehicle to be end of the line tested. This avoids time consuming manual tests that can only be conducted on a small percentage of vehicles.

In another aspect of the invention, a method is provided for detecting buzz, squeak, or rattle of interior components in a vehicle. A sine sweep signal is output through speakers of an audio system mounted in the vehicle capable of causing buzz, squeak, and rattle by defective installed parts in the vehicle. Audible sounds within the vehicle are recorded by a portable test unit during the outputting of the sine sweep signal. A component of the recorded audible sounds corresponding to the direct recording of the sweep signal is removed. Recorded audible sounds are recorded without the component to determine if a predetermined threshold is exceeded. A vehicle repair indication is generated in response to a determination that the sound exceeds the predetermined threshold.

In yet another aspect of the invention, a method is provided for detecting buzz, squeak, and rattle within a vehicle. A portable test unit is mounted within the vehicle for recording audible sound generated within an interior of the vehicle. The portable test unit communicates with a vehicle control unit for obtaining a vehicle identification number of the vehicle. The vehicle identification number is transmitted from the portable test unit to a base station unit. Vehicle accessory information is transmitted from the base station unit to the portable test unit for controlling vehicle accessory operations within the vehicle. The portable test unit commands the vehicle control unit to tune an audio system of the vehicle to a predefined frequency. A sine sweep signal is broadcast from the base station unit to the vehicle. The broadcast sine sweep signal is reproduced through the audio system of the vehicle for potentially exciting parts within the interior cabin of the vehicle. The sound is recorded within the interior cabin of the vehicle by the portable test unit during the output of the of the sine sweep signal. A sound data file as recorded is transmitted by the portable test unit to the base station unit. The sine sweep signal is removed from the sound data file. The data file is analyzed by the base station unit for determining whether any remaining sound exceeds a predetermined threshold. The base station unit communicates to the portable test unit whether the vehicle requires repair in response to the determination that the sound exceeds the predetermined threshold.

In yet another aspect of the invention, a vehicular noise detection system includes a vehicle having a vehicle control unit and a vehicle audio system. The vehicle audio system includes an antenna for receiving broadcast signals, a radio head unit for processing the received broadcast signals, and speakers for outputting signals reproduced by the radio head unit to an interior of the vehicle. The vehicle control unit communicates with a plurality of subsystems of the vehicle for monitoring and controlling a plurality of vehicle operations. A portable test unit is disposed within the vehicle for recording sound generated within the interior of the vehicle. The portable test unit is in communication with the vehicle control unit for obtaining a vehicle identifier and for controlling vehicle functionality within the vehicle. A base station unit is in communication with the portable test unit for obtaining the vehicle identifier. The base station unit communicates to the portable test unit parameters for executing a respective noise test in response to the vehicle identifier. The portable test unit commands the radio head unit to tune to a respective radio frequency. The base station unit generates a sine sweep signal that is received by the antenna and is reproduced by the vehicle audio system. The portable test unit records sound generated with the interior of the vehicle during the reproduction of the sine sweep signal. The portable test unit transmits the recorded sound data to the base station unit. The base station unit analyzes the recorded sound data for determining whether any interior trim parts excited by the sine sweep signal within the vehicle emit a sound above a predetermined threshold. The base station unit transmits a signal to the portable test unit indicating whether the vehicle passed or failed the noise test. The portable test unit generates an indication whether the vehicle passed or failed the noise and vibration test.

### BRIEF DESCRIPTION OF DRAWINGS

FIG. 1 is a block diagram of an infotainment noise checking system.

FIGS. 2a-c illustrate front, side, and rear views of a portable test unit.

FIG. 3 illustrates a perspective view of a base station unit.

FIG. 4 is a flowchart of a method for executing an end of line noise and vibration test.

FIG. 5 is a flowchart of a noise test algorithm.

### DETAILED DESCRIPTION

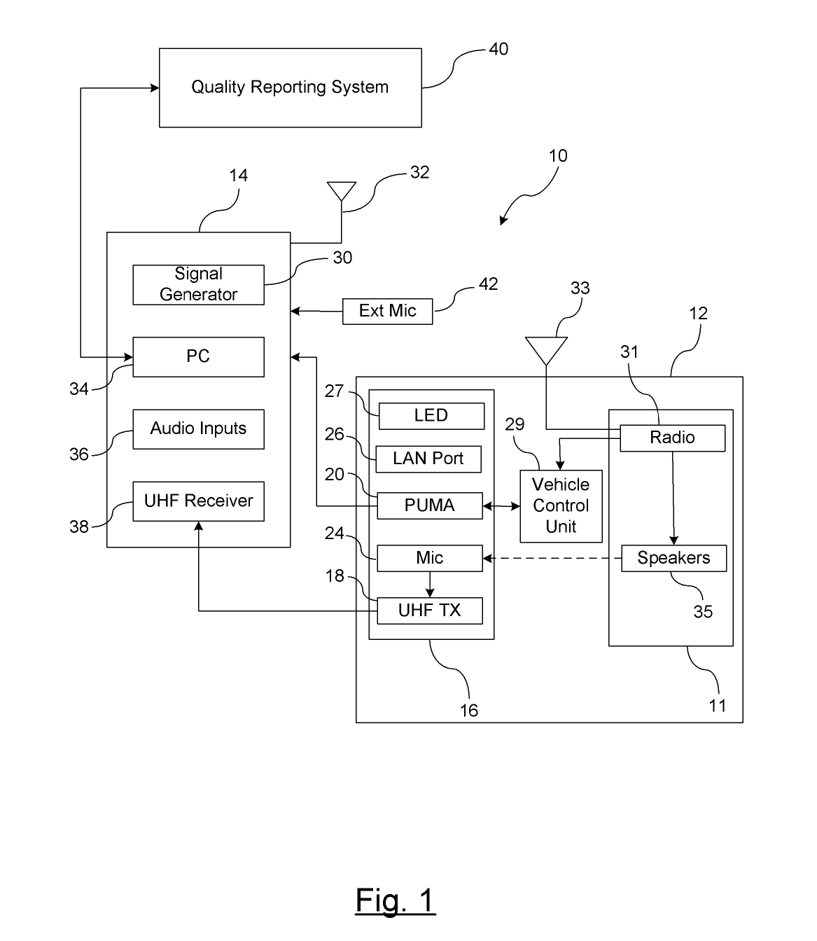

There is shown in FIG. 1, an infotainment checking system (ICS) 10 for objectively testing vehicles for buzz, squeaks, and rattles (BSR) and other noises by interfacing with the audio system 11 of the vehicle. The ICS 10 can be used to obtain objective noise and vibration measurements of every vehicle produced on a vehicle production line in order to characterize BSR noise that could be generated in the interior of a vehicle 12 during normal use by a consumer as a result of defective or improperly installed parts such as speakers or interior trim panels. The term defective installed parts may include, but is not limited to, a defective part itself, an improperly installed part that is a result of operator error, a defect in a part which inhibits installation, a defect of a fastener or improperly installed fastener that inhibits installation, an improper coupling of two or more parts, improper coupling of an electrical connection to a part.

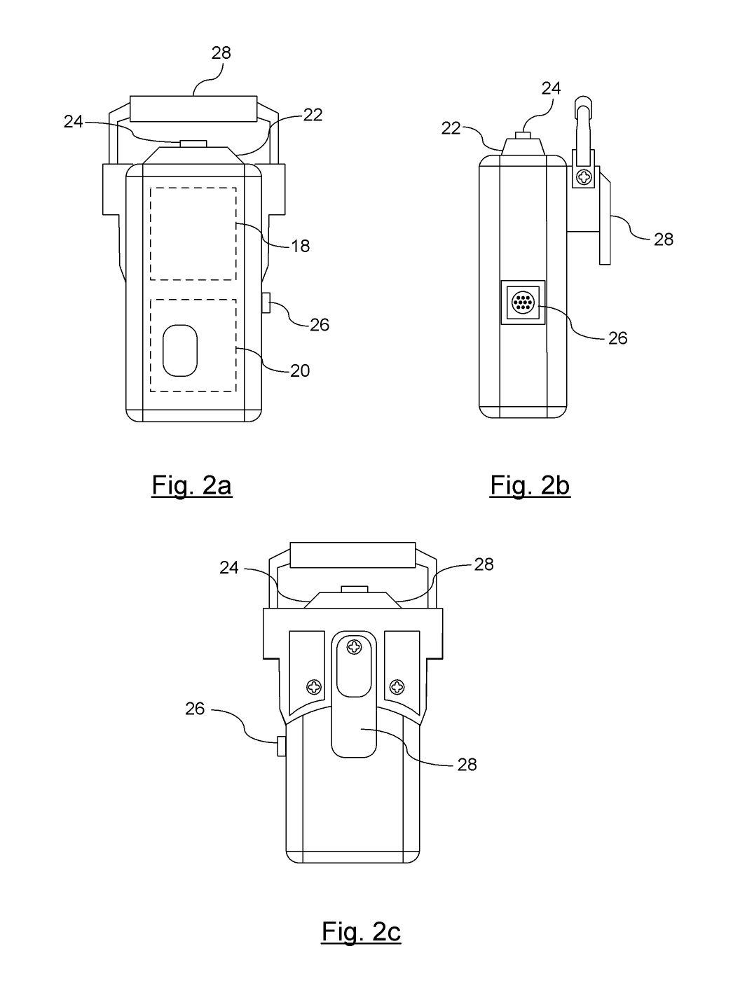

The ICS 10 includes a portable test unit 16 and vehicle portable test unit 16. The portable test unit 16 is placed within the vehicle 12 by an operator when the testing is initiated. The portable test unit 16 is placed in a same location within each vehicle, such as on a steering wheel of the vehicle. The portable test unit 16 is shown in FIGS. 2a-c. The portable test unit 16 includes a transmitter 18, a puma 20, a led indicator 22, a microphone 24, communication port 26, and a hanger/handle 28. Sound picked up by the microphone 24 is recorded in a memory (not shown). The puma 20 is a processing and diagnostic device that communicates with the portable test unit 16 and vehicle 12 for initiating and executing testing operations within the vehicle 12.

The LAN communication port 26 can be used to connect a wired line from the portable test unit 16 to the vehicle 12 so that vehicle information may be retrieved from the vehicle and also to function as a communication gateway in cooperation with a vehicle control unit 29 to exchange control signals with vehicle 12. The puma 20 receives instructions and information from the base station unit 16 and also wirelessly communicates information to the base station unit 14 including the vehicle identification number (VIN) so that base station unit 14 can retrieve information relating to specific components and associated functionality that has been installed in each particular vehicle being tested. For example, the communication port 26 may be coupled to a conventional OBD II system for communication with the vehicle control module 29 to control certain features of the vehicle, such as setting the radio volume and equalization to predetermined levels, powering off the blower motor, or powering off any other device which may cause background noises. In addition, the radio will be tuned to a respective frequency for receiving from the base station unit 14 an audible test signal to be reproduced through speakers of the vehicle for conducting the BSR test.

The UHF transmitter 18 is used to transmit data obtained from the BSR noise test conducted on the vehicle. The hanger/handle 28 is used to transport the device from vehicle to vehicle and to attach the device to the vehicle so that the testing can be performed. The hanger/handle 28 is preferably attached to the steering wheel (e.g., hung over the top of the steering wheel) so that the sound captured within the vehicle is corresponds to the driver's seated position.

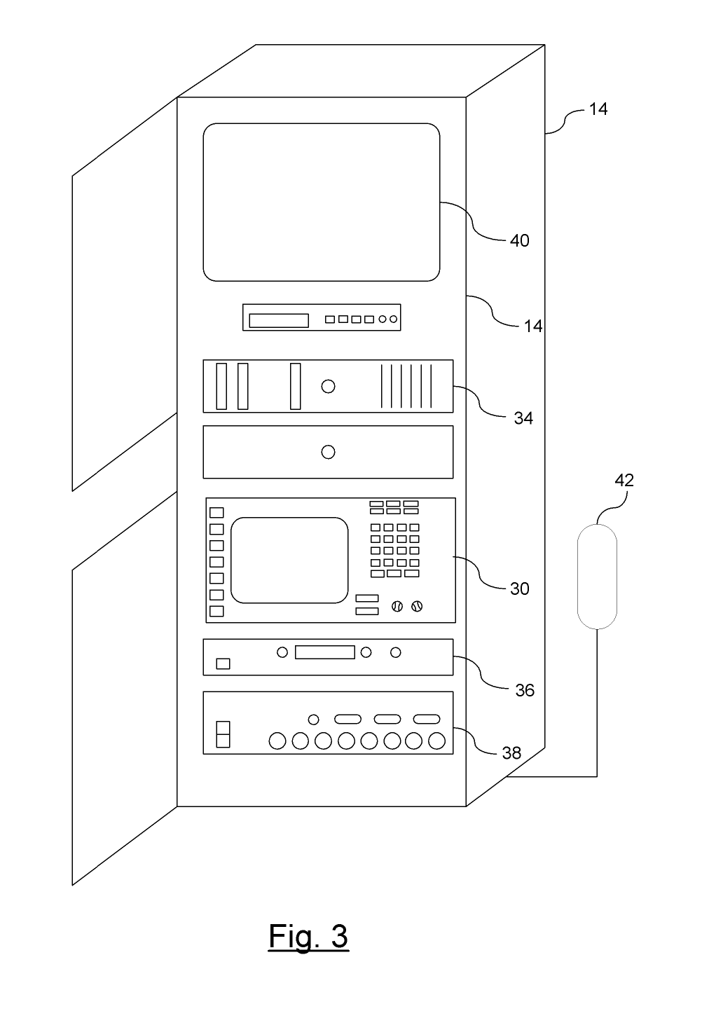

The base station unit 14, as shown in FIG. 3, is disposed within a vehicle assembly plant and located near the testing area so that it can properly communicate with the portable test unit 16. The base station unit 14 includes a signal generator 30, at least one antenna 32, a personal computer 34, an audio inputs device 36, a receiver 38, a display 40, and an external microphone 42.

Referring again to FIG. 1, the signal generator 30 is configured to generate a calibrated signal sweep (20-120 HZ) that is wirelessly transmitted via antenna 32 and is received by the radio head unit 31 via the antenna 33 and is audibly output through speakers 35 of the vehicle audio system 11. Preferably, the signal is transmitted as an FM signal. The portable device 16 records the sound data in response to the signal output from the vehicle audio system (e.g., as a data file).

The sound data is then wirelessly transmitted from the portable test unit 16 to the receiver 38 of the base station unit 14. The receiver is preferably a UHF receiver. Alternatively, the sound data can be transferred from the portable test unit 16 to the base station unit 14 via a wired connection.

The received sound data is then provided to an audio input device 36. Filtering is applied to the received sound data by the audio inputs device 36. The filtered data is then provided to a PC where BSR analysis is autonomously applied to the sound data for determining whether any quality issues have been detected within the vehicle. If a quality issue is present, then a plant quality personnel is notified and the vehicle is sent to a repair area where the problem is identified and corrected by a service technician. The service technician may perform a re-test utilizing a portable test unit and base station unit with additional programming that operates for a longer duration of time. The test program used at the repair area may isolate a BSR problem to a specific interior quadrant of the vehicle by sequentially outputting the generated signal through each speaker independently for a respective duration of time so that the system may isolate the location of the problem within the vehicle, for example.

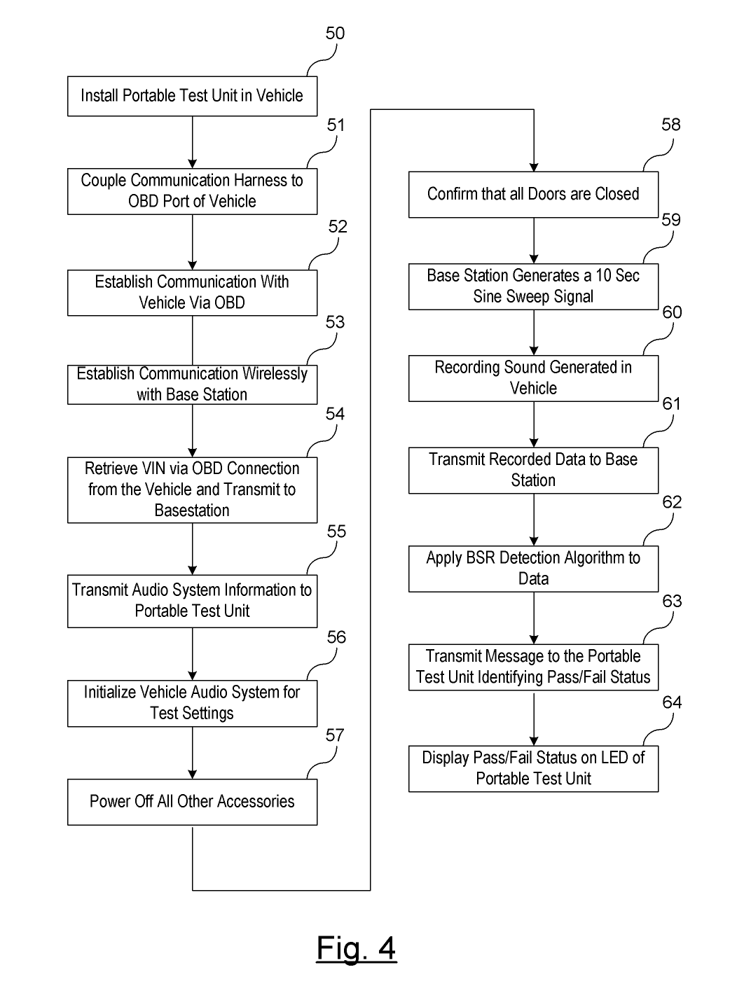

FIG. 4 illustrates a flowchart for executing an end of line BSR noise test. All vehicles are typically equipped with powerful audio systems that can induce acoustic and vibration excitation. While the audio system of the vehicle is limited to exciting potential BSR issues associated with the cabin interior trim, these comprise the majority of the things-gone-wrong (TGW) reported by the customer, and they produce the majority of the warranty cost since the interior cabin is where the customer experiences the noise issue and can more readily detect any BSR issue.

Use of the audio system facilitates consistent and repeatable tests from vehicle to vehicle. Often, the vehicle audio system can be controlled through OBDII. In addition, the audio system allows more flexibility to select a type of excitation, i.e., harmonic (such as narrow band) versus random (broadband).

The BSR test must be performed within a respective window of time since the BSR test is performed on the assembly line and each station only has a predetermined amount of time before the vehicle must move to the next station or off the line. A typical EOL cycle time for an automotive OEM is approximately sixty seconds. This implies that the time available to setup the equipment, conduct the test, and remove the equipment must be less than sixty seconds. Setup involves the operator installing the equipment in the vehicle. Conducting the test involves the BSR testing being autonomously performed by the portable test unit and the base station unit. Removal of the equipment involves the operator entering the vehicle disconnecting any communications lines and removing the portable device. Assumptions are that the ten seconds are allocated to install the equipment and another ten seconds to remove the equipment. As a result, approximately forty seconds are left for BSR test initialization and test execution.

In step 50, the operator installs the portable test unit within the interior cabin of the vehicle. Preferably, the portable test unit is attached to the top of the steering wheel which designates a region within the vehicle closest to where a driver hearing the noise would be located in the vehicle.

In step 51, the operator couples a communication harness to the OBD port of the vehicle. Typically the OBD port is located below the steering column.

In step 52, the portable test unit establishes communication with a vehicle control module through the OBD connection. The vehicle control module is used to control vehicle accessories and other functions of the vehicle (e.g., audio system and blower motor), and to obtain vehicle data such as the open or close state of the doors.

In step 53, the portable test unit establishes communication wirelessly with the base station unit.

In step 54, the portable test unit retrieves information via the OBD connection relating to vehicle information and transfers such information to the base station unit. The retrieved vehicle information includes, but is not limited to, vehicle identification number (VIN). When the base station unit retrieves the VIN, the base station unit can identify the bill of materials for the respective vehicle which provides details of the content of the vehicle trim and components (e.g., model of radio) and selects the associated BSR testing configuration for execution.

In step 55, the portable test unit initializes the vehicle audio system of the vehicle so that the radio head unit is tuned to a respective frequency so that a sweep signal that is broadcast by the base station unit is captured through a respective FM channel of the vehicle audio system.

In step 56, the portable test unit sets up the vehicle audio system so that the fade, balance, treble, and bass functions are all centered (e.g., balanced at zero). In step 57, the portable test unit communicates with the vehicle control unit to power off all noise generating accessories (e.g., blower motor). In step 58, the portable test unit waits until a signal is received from the vehicle control module confirming that all compartment doors/windows on the vehicle are closed, and then transmits a start signal to the base station unit for initiating the BSR algorithm.

In step 59, the base station unit emits a 10 second sine sweep signal from an initial frequency to a final frequency (e.g., range) that is received by the vehicle audio system and reproduced through the speakers of the vehicle. A predetermined audio volume may be employed (such as 75% of maximum). The portable test unit records the noise and vibration responses using the microphone integrated within the portable test unit.

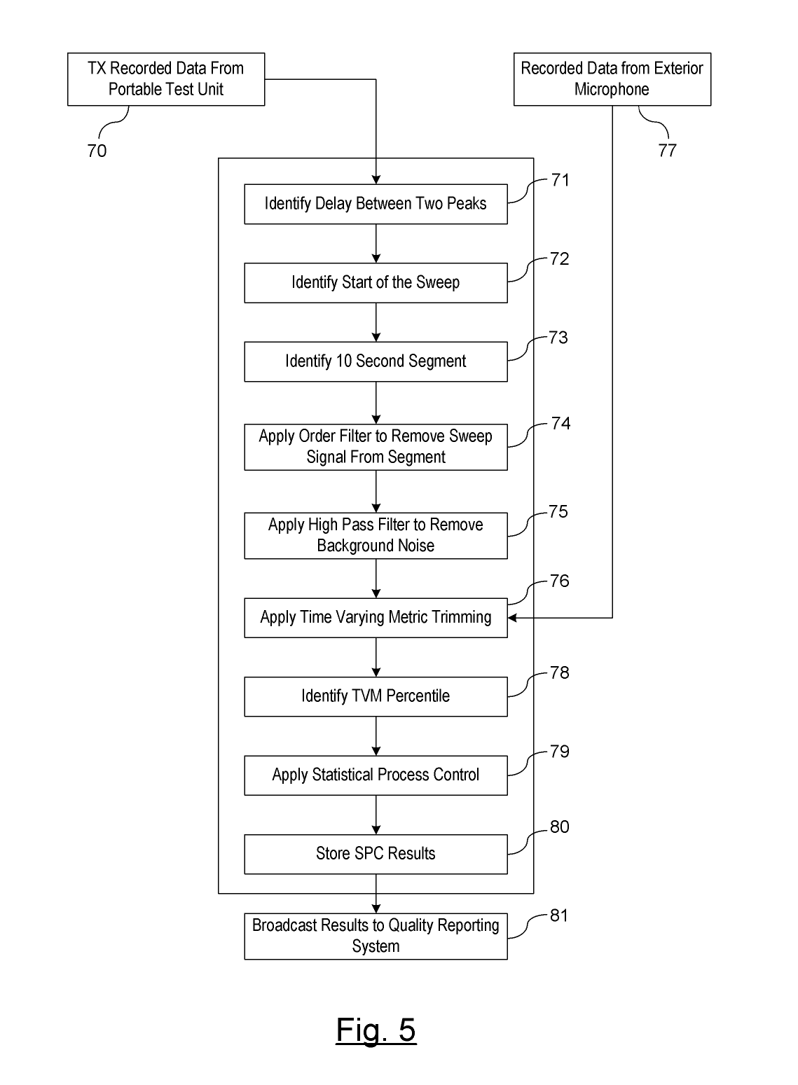

In step 60, the recording data obtained by the microphone is saved preferably as a way file by the portable test unit. In step 61, the file is wirelessly transmitted via a UHF channel to the base station unit. In step 62, a BSR detection process is executed for computing a single number metric and identifying if the vehicle has passed or failed a statistical process control threshold as will be described in more detail below in connection with FIG. 5.

In step 63, the base station unit transmits a message to the vehicle portable test unit indicating the pass/fail status. In step 64, the portable test unit indicates to the operator whether the vehicle passed or failed the BSR test. If the vehicle passed the BSR test, then a green light will be illuminated on the LED indicator and the vehicle is ready for shipping. If the vehicle failed the BSR test, then a red light will be illuminated on the LED indicator.

As a result, the above steps must be performed in 40 sec to maintain target cycle times along the assembly time. Therefore, step 62 must be completed within 15 sec. Since 5 sec would be allocated for pre and post BSR processing and reporting, the execution of the actual BSR algorithm must be performed in 10 sec for maintaining assembly line cycle time.

In step 64, if the BSR test indicates that the vehicle has failed, then the vehicle is directed to a vehicle repair area. At the vehicle repair area, a portable test unit will be mounted to the steering wheel and the BSR test will be executed for different regions of the vehicle. The different regions are analyzed by audibly outputting the sine sweep signal through each speaker consecutively. Since cycle time is not an issue in the repair area, each respective BSR test may be conducted on a single speaker one at a time for isolating and detecting the BSR issue.

FIG. 5 illustrates a flowchart of a method for detecting presence of a BSR issue. The use of the sine sweep signal offers the advantage of being able to separate the excitation sweep signal from any resulting buzz, speak, or rattle picked up within the recorded sound without requiring any additional input signals, triggers, or references. Since the rate of the sweep is known, the exact start of the sweep can be computed and then the recorded sweep signal component can be removed using an order tracking filter. The order tracking filter not only removes the sweep fundamental of the signal, but also any desired number of harmonics of the sweep. Removing the first 30 harmonics yields the best compromise between removing as much as the excitation signal from the response without having too much effect on the BSR response of the noise. However, removing too many harmonics starts to also remove some BSR noise.

The order tracking filter removes everything related to the sine sweep excitations, but does not remove low frequency environment (i.e., background) sound that tends to mask higher frequency BSR, e.g., cabin boom. Typically in the past, it has been common practice to simply use a high pass filter at 500 Hz to remove such low frequencies. The present invention may alternatively employ a time varying filter to remove the low frequencies. A time varying filter is a filter for which the cutoff frequency changes with time instead of being fixed at a respective frequency like typical high pass filters. Time varying filter cutoff parameters are preferably optimized to be 20 Hz at the beginning of the sweep, and then are linearly changed up to 120 Hz by the end of the sweep. The time-varying sweep provides for a better separation between BSR noises and background noise.

Once the recorded time signal has been filtered through the order tracking filter and time varying filter, the sound that is left is the sound associated with BSR in the vehicle. A final objective quantification of this BSR sound is done by first computing the varying energy of the sound for a duration of the recording. This is performed by computing a Root Mean Square (i.e., RMS) level for 100 ms of the recording at every 10 ms for the whole duration of the recording. The result is a time varying RMS level curve that will peak at any BSR event. Finding an absolute peak level of the time varying RMS gives the BSR level for that respective vehicle.

The following algorithm is preferably applied to the recorded data obtained by the portable test unit. In step 70, the calibrated recorded data obtained by the portable test unit is transmitted to the base station unit. In step 71, at 4 sec into the recording, a time delay is identified between two consecutive peaks. That is, a 4 sec delay, or any other predetermined time delay is used to exactly determine the start of the sine sweep. The sine sweep play back through the speaker does not exactly start at the same exact time for each run and there is no “trigger” available to indicate to the algorithm the start of the sine sweep. Since it is known that the sweep goes from 20 Hz to 120 Hz at 10 Hz/sec, then it can be determined that at 4 sec the frequency should be 60Hz which means that two consecutives peak of the time signal should be separated by 1/60=0.01667 sec. If the time is between these two consecutives peaks is slightly higher, then it is determined that the sweep started late and the actual start of the sweep can be estimated. If the time is slightly lower, then it is determined that the start of the sweep was not recorded, and depending by how much, the measurements should be rejected because too much of the beginning of the sweep is missing.

In step 72, based on the delay, the location of the start of the sweep in the audio file is determined. In step 73, a signal segment from the start of the sweep to the known end of the sweep time (e.g., exactly 10 sec long) is identified.

In step 74, order tracking filters are applied to the 10 sec segment. The order tracking filter removes the sweep generated through the speakers from the 10 sec segment. After the sweep signal generated through the speaker is removed, the noises that remain are possible BSR noises and background noises.

In step 75, a high pass filter is applied to remove any ongoing or continuous background noise from the plant. After the background noise is removed, only the BSR noise remains with the exception of intermittent noise. Intermittent noise may be external noise generated from outside of the vehicle that only lasts for a short duration of time (e.g., less than half a second). An example of intermittent noise may include another vehicle in the plant honking the horn. Typically, an operator may honk the horn to make sure the horn is operational and to make other operators aware that a vehicle is being driven off the line.

In step 76, a time varying metric (TVM) trimming is performed on the 10 sec filtered BSR segment to remove the intermittent noise. This includes obtaining a calibrated external microphone recording of the plant environment from step 77. The external microphone records the plant environment simultaneously in correlation to recording of the interior noise within the vehicle by the internal microphone. As a result, the two recordings can be compared at the same time instances. If two peaks coincide at the same time within both recordings, then an assumption is made that the noise identified was generated by noise exterior of the vehicle, as the external microphone would not capture any of the BSR noise generated from within the vehicle. As a result, 0.5 sec of data pertaining to the peak within the BSR data is removed. The remaining data within the segment should substantially only be BSR data.

In step 78, a percentile of the TVM is identified. That is, analysis is performed on the noise data from a maximum to a minimum. The routine can assign a percentage of the range to examine between the maximum and the minimum. However, the entire range may be utilized without excluding any of the BSR data between the maximum and the minimum.

In step 79, statistical process control is applied to the analyzed data. The results of the BSR data are compared to statistical process thresholds which are constantly updated. If the BSR is present, then the base station unit transmits a signal to the portable test unit indicating that the vehicle needs repair. If no BSR is present, then the base station unit transmits a signal to the portable test unit indicating that the vehicle is ready for shipping.

In step 80, the statistical process control results are stored in a SPC database for ongoing analysis to maintain conforming products. In step 81, the results are broadcast to a plant quality reporting system.

Other checks may performed by the BSR system on the unfiltered BSR data received from the portable test unit. For example, a high pass filter (10 kHz) may be applied to original BSR data for determining whether functioning connections to the tweeter speakers are present. Another example is that that sound pressure level of the original BSR data may be analyzed for determining whether all speakers are connected. In addition, an excitation sweep may be performed on the original data to analyze total order distortions which checks the overall quality of the speaker system within the vehicle. The difference is that for the total order distortions, the energy is not at a single tone/frequency, but is for the “order” which has a varying frequency throughout the sweep. For example, contrast this to total harmonic distortion (TDH). In THD, if a reproduction is played back a 100 Hz tone (single frequency sine) to a speaker, then the THD is the energy measured at 200 Hz+300 Hz+400 Hz+500 Hz and so forth, and is divided by the energy measured at 100 Hz (the original tone). In contrast to total order distortion, a reproduction is played back at a varying frequency of 20 Hz to 120 Hz in 10 seconds “order” (Sine Sweep) to a speaker. The “total order distortions” is the energy measured for the 40 Hz to 240 Hz order+60 Hz to 360 Hz order+80 Hz to 480 Hz order+100 Hz to 600 Hz order and so forth, and is divided by the energy measured at the 20 Hz to 120 Hz (the original order).

These tests applied are directed to ascertain the quality and output of the speaker itself as opposed to utilizing the reproduced audio from the speaker to excite interior trim and other components which can used to detect quality issues as described in the embodiments herein.

It should also be understood that plurality of base stations can be paired with a plurality of with a portable test units on the assembly line or the repair area to fulfill the needs of the cycle time for the assembly process.

While certain embodiments of the present invention have been described in detail, those familiar with the art to which this invention relates will recognize various alternative designs and embodiments for practicing the invention as defined by the following claims.

What is claimed is:

1. A method for detecting buzz, squeak, or rattle of interior components in a vehicle, the method comprising the steps of:
outputting a sine sweep signal through speakers of an audio system mounted in the vehicle capable of causing buzz, squeak, and rattle by defective installed parts in the vehicle;
recording audible sounds within the vehicle by a portable test unit during the outputting of the sine sweep signal;
removing a component of the recorded audible sounds corresponding to the direct recording of the sweep signal;
analyzing recorded audible sounds without the component to determine if a predetermined threshold is exceeded; and
generating a vehicle repair indication in response to a determination that the sound exceeds the predetermined threshold.

2. The method of claim 1 wherein outputting the sine sweep signal through the speakers of the audio system comprises:
setting a frequency of a vehicle radio of the audio system to a predetermined frequency
broadcasting a sine sweep signal by a base station unit to the vehicle, the base station unit being disposed remote from the vehicle; and
receiving the broadcast sine sweep signal and reproducing the sine sweep signal in the vehicle radio;

3. The method of claim 2 wherein the recorded audible sounds are recorded by the portable test unit and are transmitted by a UHF transmitter in the portable test unit to the base station unit.

4. The method of claim 3 further comprising the steps of:
communicating a vehicle identification number from the portable test unit to the base station unit; and
communicating from the base station unit to the portable test unit vehicle information identifying vehicle content and functionality for controlling operations of the vehicle.

5. The method of claim 4 wherein the vehicle information includes audio system information.

6. The method of claim 5 wherein the portable test unit cooperatively communicates with a vehicle control unit for controlling vehicle functionality, and wherein the portable test unit commands the vehicle control unit to set a vehicle radio volume to a predetermined level and power off additional accessory devices.

7. The method of claim 1 wherein the sine sweep signal is approximately 20-120 Hz.

8. The method of claim 1 wherein the audible sounds are recorded as a data file transmitted to the base station unit as a way file.

9. The method of claim of claim 1 wherein analyzing the recorded audible sounds comprises the steps of:
applying an order tracking filter for removing the component;
applying a high pass filter to the recorded audible sound for removing factory background noise; and
recording audible sounds exterior of the vehicle utilizing a microphone disposed exterior of the vehicle over a same duration of time as the outputting of the sine sweep angle;
comparing the audible sounds recorded by the microphone exterior of the vehicle with the audible sounds recorded by the portable test unit for identifying a same sound captured by both the exterior microphone and the portable test unit at substantially a same instance of time;
trimming respective segments from recorded audible sounds recorded by the portable test unit, the respective segments relating to the same sounds captured by both the exterior microphone and the portable test unit at substantially a same instance of time.

10. The method of claim 1 further comprising the step of applying a high pass filter to the audible sound recorded by the portable test unit for determining whether a tweeter speaker is connected.

11. The method of claim 1 the base station communicates the vehicle repair indication to the portable test unit.

12. A method for detecting buzz, squeak, and rattle within a vehicle, the method comprising the steps of:
mounting a portable test unit within the vehicle for recording audible sound generated within an interior of the vehicle;
communicating with a vehicle control unit for obtaining a vehicle identification number of the vehicle;
transmitting the vehicle identification number from the portable test unit to a base station unit;
transmitting vehicle accessory information from the base station unit to the portable test unit for controlling vehicle accessory operations within the vehicle;
the portable test unit commanding the vehicle control unit to tune an audio system of the vehicle to a predefined frequency;
broadcasting a sine sweep signal from the base station unit to the vehicle;
reproducing the broadcast sine sweep signal through the audio system of the vehicle for potentially exciting parts within the interior cabin of the vehicle;
recording the sound within the interior cabin of the vehicle by the portable test unit during the output of the of the sine sweep signal;
transmitting a sound data file as recorded by the portable test unit to the base station unit;
removing the sine sweep signal from the sound data file;
analyzing the data file by the base station unit for determining whether any remaining sound exceeds a predetermined threshold; and
the base station unit communicating to the portable test unit whether the vehicle requires repair in response to the determination that the sound exceeds the predetermined threshold.

13. A vehicular noise detection system comprising:
a vehicle including a vehicle control unit and a vehicle audio system, the vehicle audio system including an antenna for receiving broadcast signals, a radio head unit for processing the received broadcast signals, and speakers for outputting signals reproduced by the radio head unit to an interior of the vehicle, the vehicle control unit communicating with a plurality of subsystems of the vehicle for monitoring and controlling a plurality of vehicle operations;
a portable test unit disposed within the vehicle for recording sound generated within the interior of the vehicle, the portable test unit being in communication with the vehicle control unit for obtaining a vehicle identifier and for controlling vehicle functionality within the vehicle; and
a base station unit in communication with the portable test unit for obtaining the vehicle identifier, the base station unit communicating to the portable test unit parameters for executing a respective noise test in response to the vehicle identifier;
wherein the portable test unit commands the radio head unit to tune to a respective radio frequency, wherein the base station unit generates a sine sweep signal that is received by the antenna and is reproduced by the vehicle audio system, wherein the portable test unit records sound generated with the interior of the vehicle during the reproduction of the sine sweep signal, wherein the portable test unit transmits the recorded sound data to the base station unit, wherein the base station unit analyzes the recorded sound data for determining whether any interior trim parts excited by the sine sweep signal within the vehicle emit a sound above a predetermined threshold, wherein the base station unit transmits a signal to the portable test unit indicating whether the vehicle passed or failed the noise test, and wherein the portable test unit generates an indication whether the vehicle passed or failed the noise and vibration test.

14. The vehicular noise detection system of claim 13 wherein the portable test unit includes a processing and diagnostic device, a microphone, and a transmitter.

15. The vehicular noise detection system of claim 14 wherein the pass-through diagnostic device manages diagnostic service protocols within a vehicle communication network.

16. The vehicular noise detection system 15 wherein the pass-through diagnostic device communicates with the radio head unit for controlling radio settings through the vehicle communication network.

17. The vehicular noise detection system of claim 14 wherein the pass-through diagnostic device includes a wireless transmitter for communicating with the base station unit, wherein information relating to the vehicle identifier, vehicle audio system content, and noise testing instructions are communicated from the base station unit to the portable test unit utilizing the wireless transmitter of the pass-through diagnostic device.

18. The vehicular noise detection system of claim 14 wherein the transmitter includes a UHF transmitter for transmitting the recorded sound data to the base station unit.

19. The vehicular noise detection system of claim 13 wherein the base station unit includes a UHF receiver for receiving the recorded sound data transmitted by the transmitter of the portable test unit.

20. The vehicular noise detection system of claim 13 wherein the base station unit includes a personal computer for executing a noise analysis program for analyzing the recorded sound data, wherein the noise analysis program determines whether any parts excited by the sine sweep signal within the vehicle emit a sound above the predetermined threshold.

21. The vehicular noise detection system of claim 13 wherein the base station unit includes a signal generator for generating the sine sweep signal, wherein the sine sweep signal sweeps from about 20 Hz to about 120 Hz in a predetermined time.

22. The vehicular noise system of claim 13 further comprising a quality reporting system in communication with the base station unit for maintaining reports of the sound tests conducted on a plurality of vehicles, the quality reports including statistical process control for maintaining conforming products.
